(19) United States
(12) Patent Application Publication
(10) Pub. No.: US 2013/0141047 A1
(43) Pub. Date: Jun. 6, 2013

(54) BATTERY MANAGEMENT SYSTEM AND METHOD THEREOF

(71) Applicants: Jen-Chin HUANG, New Taipei City (TW); Zhijian LIU, Changshu City (CN)

(72) Inventors: Jen-Chin HUANG, New Taipei City (TW); Zhijian LIU, Changshu City (CN)

(73) Assignees: Golden Crown New Energy (HK) Limited, Kowloon (HK); Suzhou Golden Crown New Energy Co., Ltd., Changshu City (CN)

(21) Appl. No.: 13/364,154

(22) Filed: Feb. 1, 2012

(30) Foreign Application Priority Data
Dec. 2, 2011 (CN) 201110395146.7
Dec. 2, 2011 (CN) 201110395149.0
Dec. 2, 2011 (CN) 201110395153.7

(51) Int. Cl. H02J 7/00

(52) U.S. Cl. 320/116

(57) ABSTRACT

The present invention relates to a battery management system and a method thereof. The system includes a number of battery units connected in series, a DC/DC converter module and a controller controlling the DC/DC converter module to operate under one of at least two operation modes. The battery units include a given battery unit needed to be charged. When the DC/DC converter module operates in a first operation mode, the DC/DC converter module receives and reduces a total voltage of all the battery units and transmits the reduced voltage to charge the given battery unit. When the DC/DC converter module operates in a second operation mode, the DC/DC converter module receives and converts a cumulated voltage of part of the battery units and transmits the converted voltage to charge the given battery unit.

### CROSS-REFERENCE TO RELATED APPLICATIONS

This application claims priority to and the benefit of, pursuant to 35 U.S.C. §119(a), Chinese patent application Nos. 201110395146.7, 201110395149.0 and 201110395153.7, all filed Dec. 2, 2011. The disclosure of each of the above-identified Chinese patent applications is incorporated herein by reference in its entirety.

This application is related to a co-pending U.S. patent application Ser. No. 13/363,925, entitled “BATTERY MANAGEMENT SYSTEM”. The co-pending application was filed on Feb. 1, 2012, with the same inventors and the same assignee as that of this application. The disclosure of the co-pending application is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference.

### FIELD OF THE INVENTION

The present invention relates generally to a battery management system and method, and more particularly to a battery management system and method for actively balancing voltage levels of a series-connected battery string.

### BACKGROUND OF THE INVENTION

Battery management systems (BMS) usually take charge of calculating voltage levels of individual cells in a battery to protect the battery from being over-charged or over-discharged, and monitoring signal transmission inside/outside of the battery. In existing technologies, nearly all of battery-driving products need the battery management systems.

Since it is difficult to assure all the batteries to have absolute equalities during battery manufacturing, some problems may occur when such batteries are connected in series to form a battery pack. For example, during charging of a battery module, even if some battery units in the battery module are still not saturated, some other battery units may have been overcharged. During discharging of the battery module, when some battery units still have power, some other battery units may have been over-discharged. In addition, if the battery units get overcharged or over-discharged for a long time, battery constructing materials may be degraded. As a result, the difference between characteristics of the battery units will be amplified by such degradation.

In order to solve the above problems, in existing technologies, battery management systems are used to balance power of the battery units. There are two types of conventional power balancing methods, one of which is called passive power balance and the other is called active power balance. In the passive power balance method, redundant power of the battery units is transformed to heat by resistances and then dissipated. However, such passive power balance method can only be realized during charging. The active power balance method adopts a power transition manner, in which redundant power of the battery modules is transmitted to corresponding battery units with less power. Such active power balance method can be realized either in charging or discharging to meet broader needs.

However, the conventional battery management systems with the active power balance method employ DC/DC converters to convert the voltage of all the battery units of the battery pack so as to charge the given battery units needed to be charged. However, such process needs long balance time. In addition, the conventional active power balance method requires many judging and starting steps so that efficiency thereof is low as well.

Therefore, an improved battery management system and a method for making the battery management system are desired.

### BRIEF SUMMARY OF THE INVENTION

The present invention provides a battery management system including a plurality of battery units connected in series, a DC/DC converter module and a controller controlling the DC/DC converter module to operate under one of at least two operation modes. The battery units include a given battery unit needed to be charged. When the DC/DC converter module operates in a first operation mode, the DC/DC converter module converts a total voltage of all the battery units to a reduced voltage for charging the given battery unit. When the DC/DC converter module operates in a second operation mode, the DC/DC converter module converts a cumulated voltage of part of the battery units to a converted voltage for charging the given battery unit.

The present invention further provides a method for actively balancing a plurality of battery units connected in series. The method includes the following steps:
(a) obtaining a voltage value of each individual battery unit or of each group of battery units among all the battery units;
(b) determining whether a maximum voltage value of the voltage values of the battery units is higher than or equal to a first voltage threshold;
(c) if the maximum voltage value is higher than or equal to the first voltage threshold, further determining whether there exists a special voltage value among the voltage values, the special voltage value having a minus numerical value higher than or equal to a second voltage threshold with respect to the maximum voltage value; and
(d) if the special voltage value exists, activating an active balancing to charge a given battery unit having the special voltage value.

The present invention further provides a battery management system including a plurality of battery modules each comprising a plurality of battery units connected to each other in series, a first-stage DC/DC converter adapted for obtaining a total voltage of the battery modules and outputting a first output voltage lower than the total voltage, at least one output DC/DC converter adapted for obtaining output from at least one of the battery units and outputting a second output voltage, a plurality of second-stage DC/DC converters electrically connected with the plurality of battery modules respectively, and a controller. The battery units include a given battery unit needed to be charged, and one of the second-stage DC/DC converters corresponding to the battery module including the given battery unit is adapted for obtaining output of the first-stage DC/DC converter or for obtaining output of the at least one output DC/DC converter, and outputting current to charge the given battery unit. The controller is adapted for determining the given battery unit and for determining whether the at least one output DC/DC converter is selected to output current to the second-stage DC/DC converters or not.

The foregoing has outlined rather broadly the features and technical advantages of the present invention in order that the detailed description of the invention that follows may be better understood. Additional features and advantages of the invention will be described hereinafter and form the subject of the claims of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a schematic circuit diagram of a battery management system in accordance with a first embodiment of the present invention;

FIG. 2 is a schematic circuit diagram of a battery management system in accordance with a second embodiment of the present invention;

FIG. 3A-FIG. 3C are a schematic circuit diagram of a controller of the battery management system in accordance with an illustrated embodiment of the present invention;

FIG. 4 is a schematic circuit diagram of a voltage sensing module of the battery management system in accordance with an illustrated embodiment of the present invention;

FIG. 5A-FIG. 5C are a schematic circuit diagram of a second-stage DC/DC converter of the battery management system in accordance with an illustrated embodiment of the present invention;

FIG. 6A-FIG. 6B are a schematic circuit diagram of an output DC/DC converter of the battery management system in accordance with an illustrated embodiment of the present invention;

FIG. 7 is a schematic circuit diagram of an optical isolator module of the battery management system in accordance with an illustrated embodiment of the present invention;

FIG. 8 is a schematic circuit diagram of a switch module of the battery management system in accordance with an illustrated embodiment of the present invention; and

FIG. 9 is a schematic flow chart showing steps for actively balancing a given battery unit in accordance with an illustrated embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

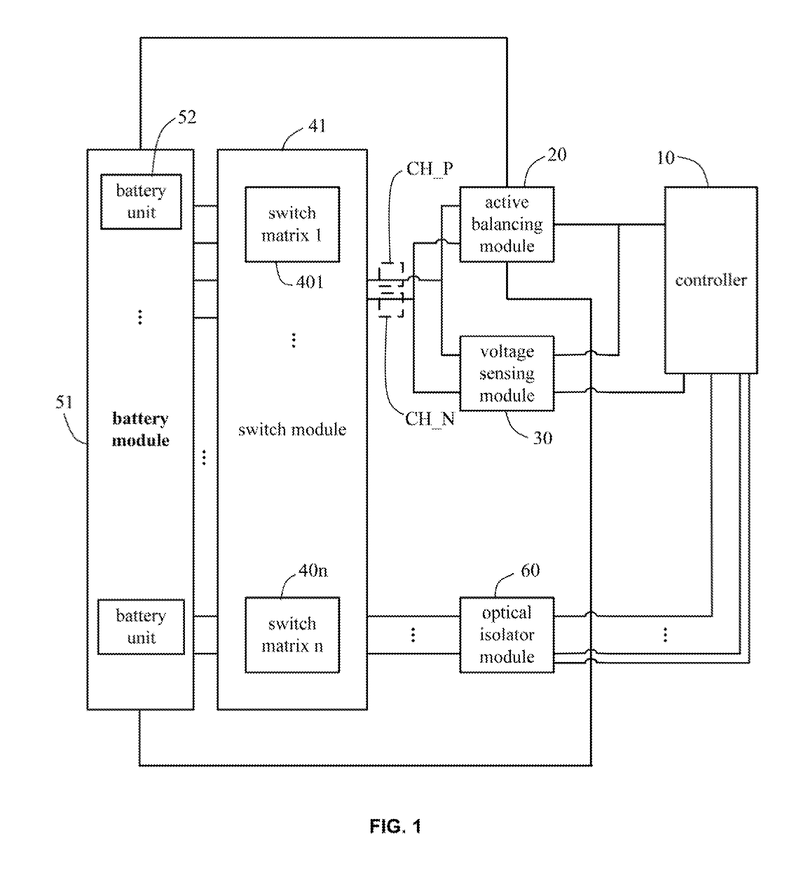

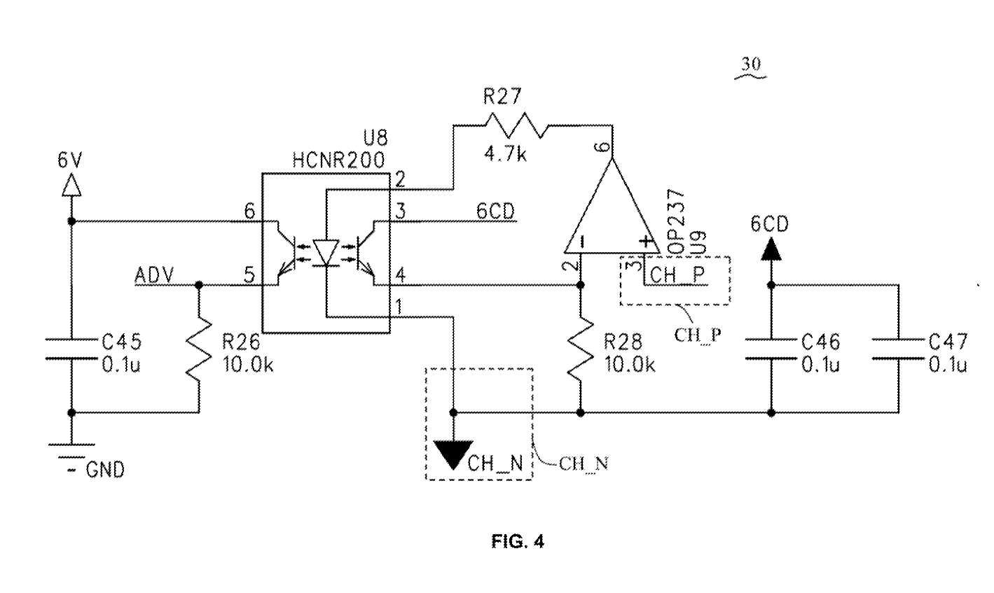

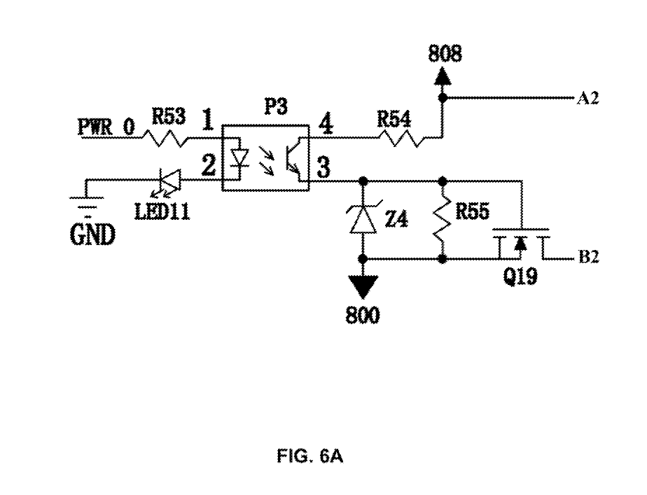

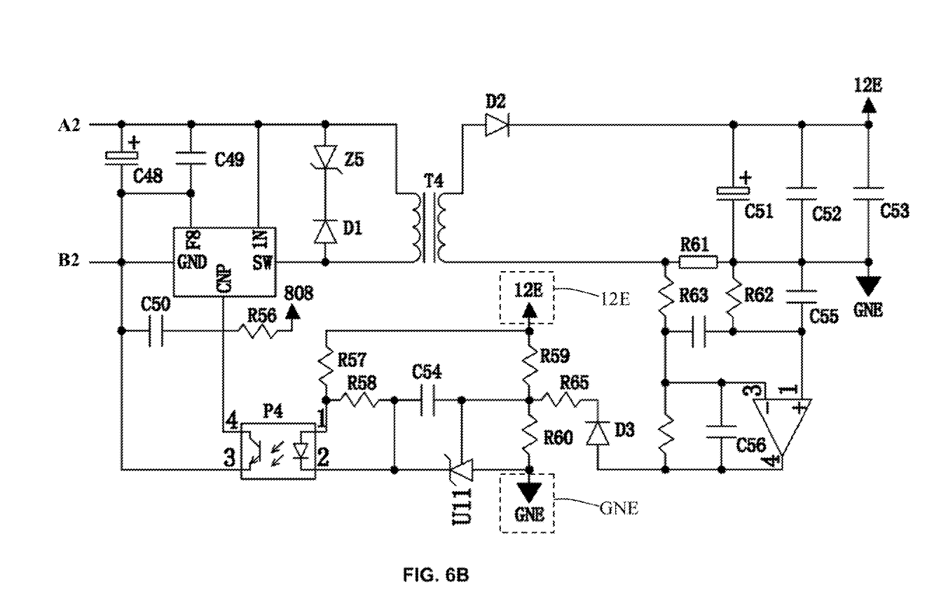

The description will be made as to the embodiments of the present invention in conjunction with the accompanying drawings in FIGS. 1-9. Reference will be made to the drawing figures to describe the present invention in detail, wherein depicted elements are not necessarily shown to scale and wherein like or similar elements are designated by same or similar reference numeral through the several views and same or similar terminology. In accordance with the purposes of this invention, as embodied and broadly described herein, this invention, in one aspect, relates to a battery module and a bracket assembly thereof for positioning batteries.

In accordance with multiple embodiments of the present invention, a battery pack includes a plurality of battery units connected in series. Alternatively, in other embodiments, the plurality of battery units can be grouped, either in the same amount or in different amounts, to form multiple battery modules.

Referring to FIG. 1, in accordance with a first embodiment of the present invention, a battery management system includes a plurality of battery units 52, a voltage sensing module 30, an active balancing module 20, a controller and a pair of signal buses CH_P, CH_N. In the instant embodiment, the battery units 52 constitute a battery module 51 which is further connected in series with other battery modules to ultimately form a battery pack. Alternatively, in other embodiments, the battery units 52 can directly constitute the battery pack.

The controller is electrically connected with the voltage sensing module 30 and the active balancing module 20. Through controlling the voltage sensing module 30, voltage of each battery unit 52 can be selectively detected and the battery unit 52 needed to be charged can be determined according to corresponding obtained voltage signals. In the context of the present invention, the battery unit 52 needed to be balanced, such as charged, is called a given battery unit 52. The controller is also adapted for receiving total voltage of all the battery units 52 through controlling the active balancing module 20 and for controlling charging the given battery unit 52.

The signal buses CH_P, CH_N are set to alternatively connect with positive and negative poles of corresponding battery unit 52. In addition, the signal buses CH_P, CH_N are connected with the voltage sensing module 30 and the active balancing module 20. As a result, the signal buses CH_P, CH_N not only provide an electric current path for the voltage sensing module 30 to detect the voltage of the battery units 52, but also provide an electric current path for the active balancing module 20 to charge the given battery unit 52.

The battery management system further includes a switch module 41 connected between the battery units 52 and the controller. The switch module 41 includes a plurality of switch matrixes designated 401, 402 . . . 40n. Through controlling on/off status of the corresponding switch matrixes, the controller is capable of establishing electrical connection between the signal buses CH_P, CH_N and the corresponding battery unit 52. In the instant embodiment, both the voltage sensing process and the active balancing process of the battery units 52 are respectively accomplished in different periods so that the controller needs to operate at least in a sensing period and an active balancing period, which will be described in detail hereinafter.

When the controller operates in the sensing period, electrical connection is established between the battery unit 52 to be checked and the signal buses CH_P, CH_N via the switch module 41 under the control of the controller, and simultaneously, corresponding voltage signal of such battery unit 52 is obtained through the signal buses CH_P, CH_N via the voltage sensing module 30 under the control of the controller. When the controller operates in the active balancing period, electrical connection is established between the given battery unit 52 to be charged and the signal buses CH_P, CH_N under the control of the controller, and simultaneously, such given battery unit 52 is charged via the active balancing module 20.

Preferably, if the total time of the sensing period and the active balancing period includes two seconds, such two seconds would be equally divided into eight phases, among which the first phase is adapted for detecting and the remaining phases are adapted for active balancing. In other words, the sensing period is one seventh of the active balancing period. For example, in the first 0.25 second, the voltage sensing module 30 and the switch module 41 are controlled by the controller so as to detect the voltage of the battery units 52 one by one. In the following 1.75 seconds, the active balancing module 20 and the switch module 41 are controlled by the controller so as to charge the given battery unit 52 lack of power. The above two steps are then alternatively circulated. It should be noted that, in some embodiments, timing of the sensing period and the active balancing period can be adjusted according to different design requirements. Further, during the sensing period, in addition to the voltage, other parameters such as current and battery temperatures can also be detected.

It is well-known to those of ordinary skill in the art that the switch module 41 may include triodes, Silicon Controlled Rectifiers (SCRs), relay switches, Metallic Oxide Semiconductor Field Effect Transistors (MOSFETs), etc. In the instant embodiment, the switch module 41 utilizes MOSFETs and each switch matrix includes four MOSFETs.

The controller may include a Micro Controller Unit (MCU) having a Central Processing Unit (CPU), a Read-Only Memory (ROM) and a Random Access Memory (RAM), a timing module, an A/D converter, and multiple input/output ports. Alternatively, the controller can also use other types of integrated circuits, such as Application Specific Integrated Circuit (ASIC) and Field Programmable Gate Array (FPGA), etc.

Referring to FIG. 1, preferably, an optical isolator module 60 is provided to connect between the switch module 41 and the controller. The optical isolator module 60 includes a plurality of optical couplers corresponding to the switch matrixes 401, 402 . . . 40n. The on/off status of each switch matrix 401, 402, . . . , 40n is controlled by the controller via each corresponding optical isolator. Further, the optical isolator module 60 is capable of shielding noise signals generated by the electric current of the battery management system. As a result, noise influence to the controller is eliminated and stable operation of the battery management system is assured. In the instant embodiment, the active balancing module 20 further includes a second-stage DC/DC converter corresponding to the battery module 51. Electric current coming from the battery module 51 is reduced by the second-stage DC/DC converter and then is transmitted into the given battery unit 52.

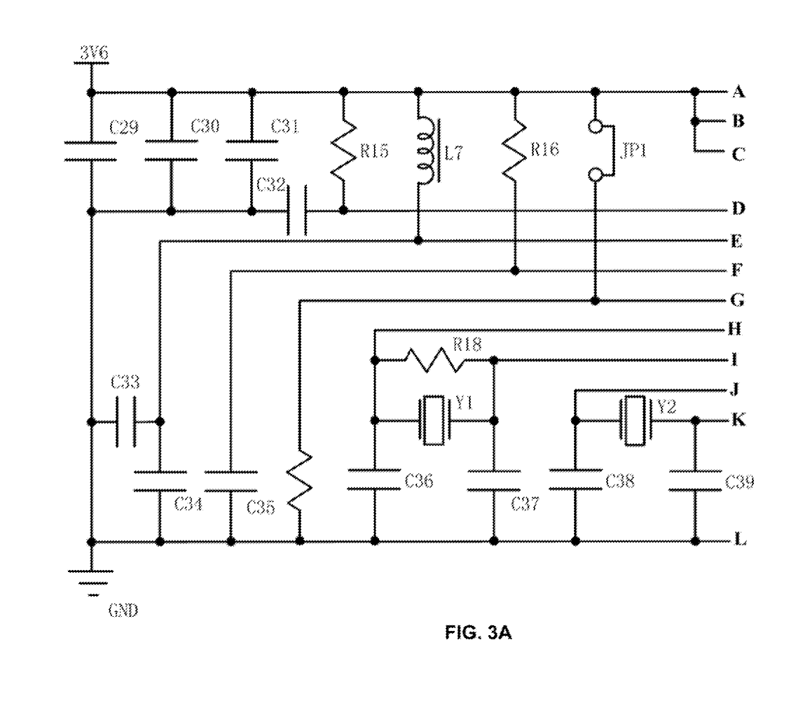

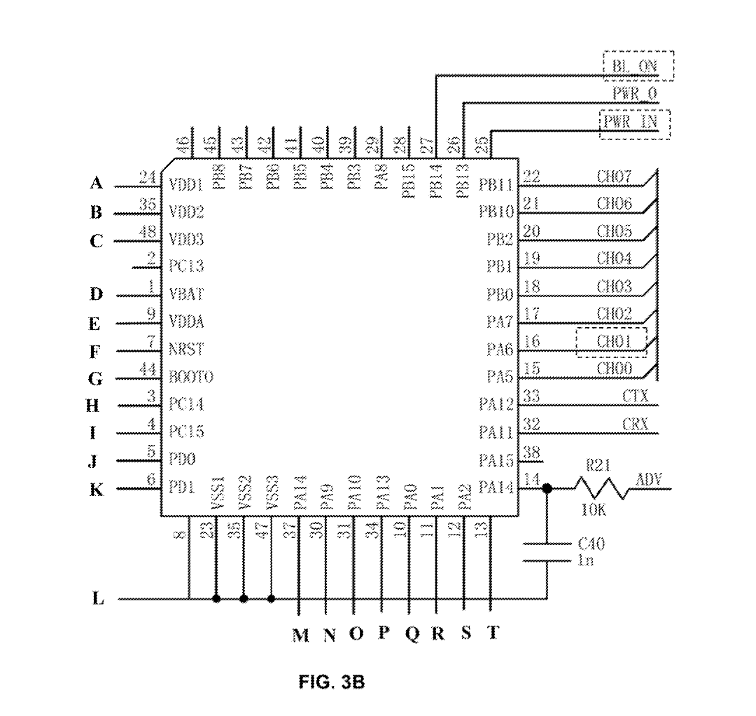

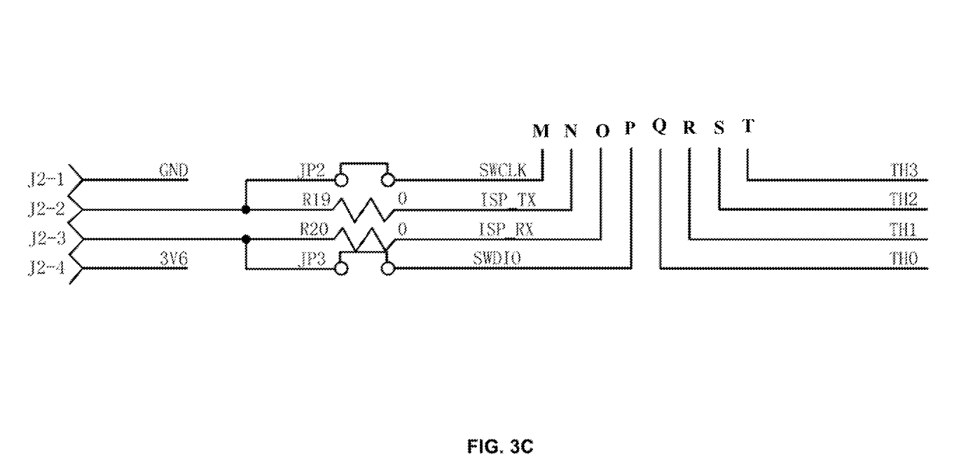

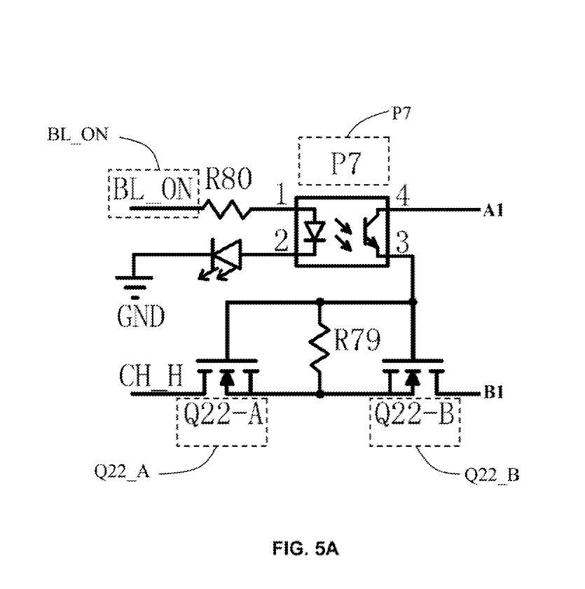

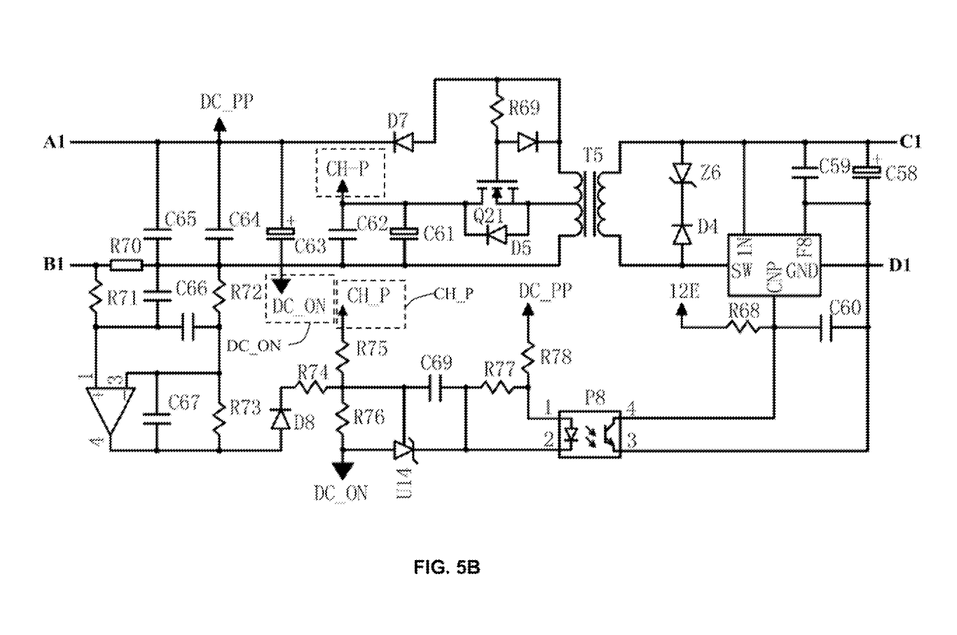

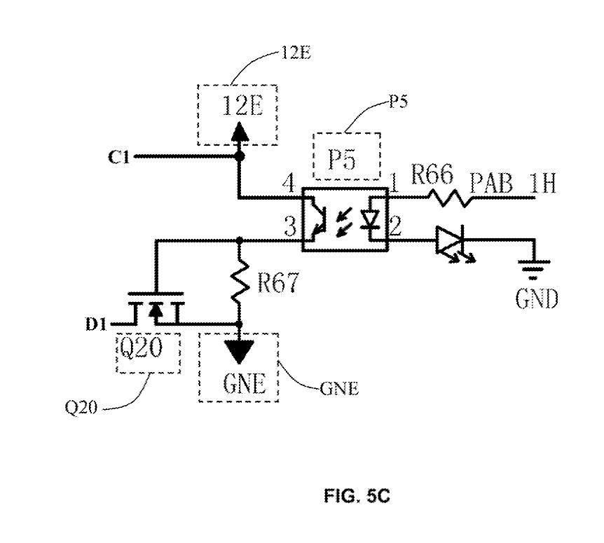

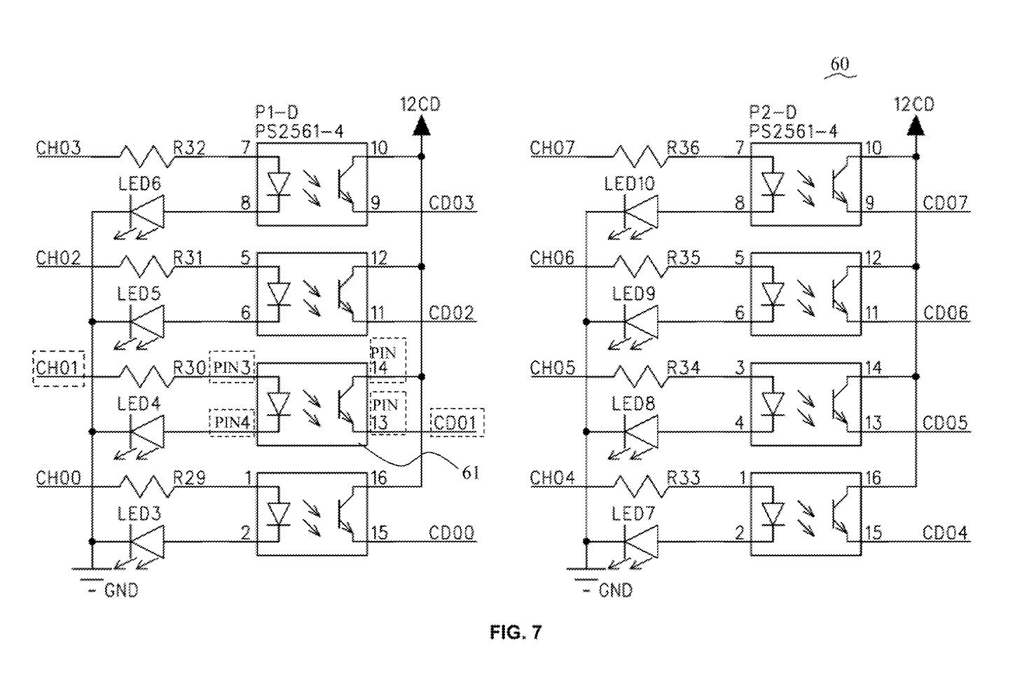

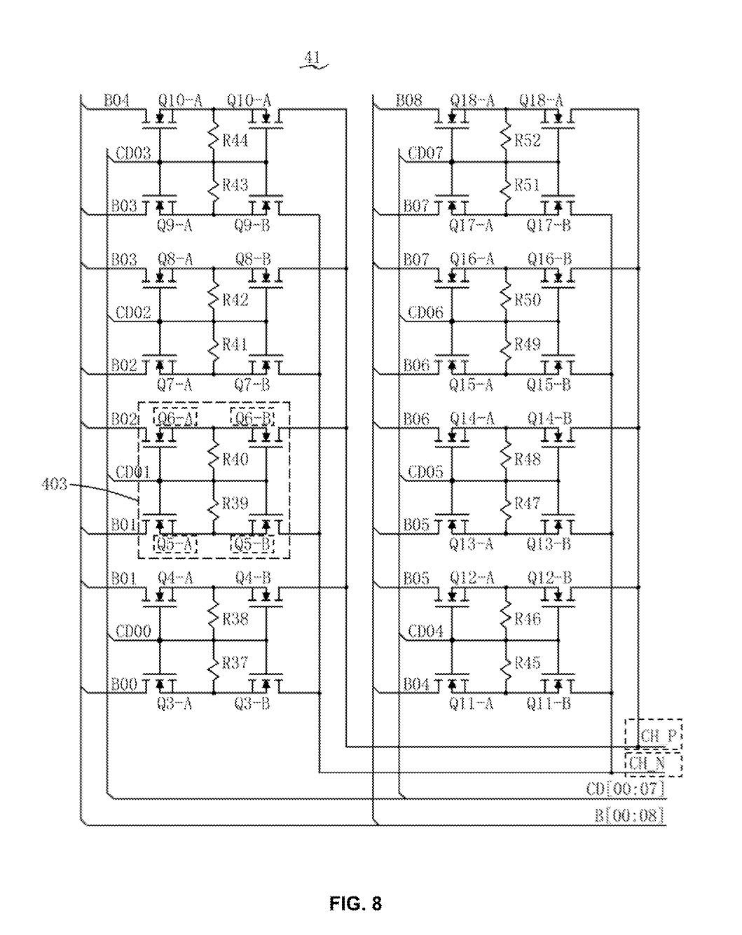

Referring to FIGS. 3A to 8, the controlling process of the switch matrixes, each including four MOSFETs, by the controller is hereafter described in details. In the instant embodiment, the controller is a STM32 series MCU of ARM corporation. Firstly, high-level signals CH01, PWR_IN, and BL_ON are respectively outputted by ports 16, 25, and 27 of the MCU. Then, as shown in FIG. 7, the high-level signal CH01 drives the ports PIN 3, PIN 4, PIN 13, and PIN 14 of the optical coupler 61 to turn on so that the power signal 12CD is inputted into the web CD01. Referring to FIG. 8, since grids of the switches Q5-A, Q5-B, Q6-A, Q6-B are connected with the web CD01, the switch matrix 403 comprised of the switches Q5-A, Q5-B, Q6-A, Q6-B is turned on so as to bridge the webs B01, B02 and the signal buses CH_P, CH_N, respectively. As shown in FIGS. 5A-5C, the high-level signal PWR_IN drives P5 and Q20 to turn on so that the external power sources 12E and GNE provide power for the second-stage DC/DC converter. At the same time, the second-stage DC/DC converter operates to generate a balancing voltage about 3.5V. Further, the high-level signal BL_ON drives P7, Q22-A, and Q22-B to turn on so that the signal bus CH N connects with DC ON. As a result, the switch matrix 403 of the switch module 41 is turned on so that the active balancing module 20 and the voltage sensing module 30 are capable of detecting the voltage of the corresponding battery unit 52 via the switch matrix 403, and the given battery unit 52 can be charged if balancing is required.

According to the illustrated embodiment of the present invention, with the signal buses CH_P, CH_N connected between the active balancing module 20 and the voltage sensing module 30, the controller is capable of controlling the voltage sensing module 30 so as to transmit the voltage sensing signals through the signal buses CH_P and CH_N. Further, the controller is also capable of controlling the active balancing module 20 so as to charge the given battery units 52 through the signal buses CH_P and CH_N. As a result, circuit infrastructure of the battery management system is simplified and the number of the optical couplers 61 is reduced, thereby saving designing and manufacturing costs.

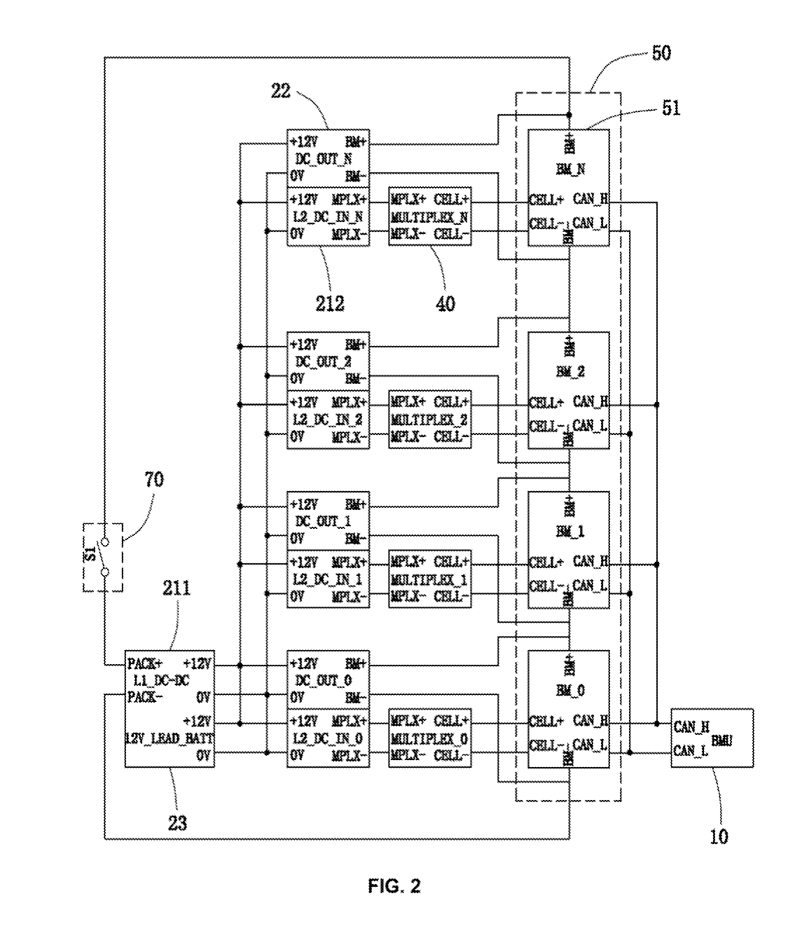

Referring to FIG. 2, in accordance with a second embodiment of the present invention, a battery management system includes a battery pack 50, a controller, an active balancing module, a voltage sensing module, a switch module and an optical isolator module etc. For simplifying description, the voltage sensing module is not shown, and the switch module and the optical isolator module are collectively known as a switch circuit 40. In this embodiment, the active balancing module includes a DC/DC converter module for converting direct current from one scale to another. The battery pack 50 includes a plurality of battery modules 51 in series connection, and each battery module 51 further includes a plurality of battery units 52 in series connection as well.

The DC/DC converter module includes a first-stage DC/DC converter 211, a plurality of second-stage DC/DC converters and a plurality of output DC/DC converters. The first-stage DC/DC converter 211 is capable of obtaining a total voltage of the battery modules 51 of the battery pack 50, and is capable of outputting a first output voltage lower than the total voltage by DC conversion. The output DC/DC converters are capable of obtaining output signals from at least one of the battery units 52 of corresponding battery module 51, and are capable of outputting a second output voltage. In this embodiment, the output DC/DC converters obtain all output signals from the battery units 52 of the battery modules 51. The second-stage DC/DC converters are connected with corresponding battery modules 51 and are capable of obtaining the output voltages of the first-stage DC/DC converter 211 and at least one of the output DC/DC converters. Further, the second-stage DC/DC converters are capable of selectively outputting current to charge the given battery unit 52 of the corresponding battery module 51.

In this embodiment, the controller obtains voltage signals of the battery units 52 through the voltage sensing module, and determines the given battery unit 52 to be charged according to the voltage signals. In addition, the controller further determines whether at least one of the output DC/DC converters is turned on or whether the output of the whole battery pack 50 is turned on to provide power for balancing.

In detail, the first-stage DC/DC converter 211 and the output DC/DC converters are connected in parallel, and the second output voltage of the output DC/DC converters is higher than the first output voltage of the first-stage DC/DC converter 211. The advantage of such arrangement is that the output DC/DC converters are capable of outputting power prior to the first-stage DC/DC converter 211. For example, the first output voltage can be 12V and the second output voltage can be 15V, and when the output power through one or more battery modules 51 is determined by the controller, the output DC/DC converters, and not the first-stage DC/DC converter 211, are selected for outputting required balancing power, thereby reducing power balancing time and improving system efficiency.

Preferably, the output DC/DC converters are capable of obtaining all the output signals of the battery units 52 of the corresponding battery modules 51, and are capable of charging the given battery units 52 through the corresponding second-stage DC/DC converters. However, in other embodiments, the output DC/DC converters are capable of obtaining the output signals of only one or more of the battery units 52 with more power of the corresponding battery modules 51, and are capable of charging the given battery unit 52 through the corresponding second-stage DC/DC converters for charging the given battery units 52.

Preferably, the battery management system further includes a power storage apparatus 23 combined with the first-stage DC/DC converter 211. The power storage apparatus 23 is adapted for storing power outputted by the first-stage DC/DC converter 211 and is capable of providing power for the second-stage DC/DC converters.

In this embodiment, a plurality of the switch circuits 40 is provided and each switch circuit 40 is connected between each second-stage DC/DC converter and the corresponding battery module 51. Each switch circuit 40 includes an optical coupler and a plurality of switch matrixes 401, 402, . . . , 40n corresponding to the battery units 52 of the battery modules 51. Electrical connection can be established between the second-stage DC/DC converter and the given battery unit 52 through turning on/off the corresponding switch matrixes 401, 402, . . . , 40n under the control of the controller. Since the operation of the switch matrixes 401, 402, . . . , 40n under the control of the controller has been described in detail in the first embodiment, description thereof is omitted herein. However, in some embodiments, all the battery units 52 of the corresponding battery modules 51 can be charged. In this case, the battery units 52 get charged one by one via the switch matrixes 401, 402, . . . , 40n are alternatively turned on under the control of the controller. In other words, in each process, only one of the switch matrixes 401, 402, . . . , 40n is turned on, and subsequently another different switch matrix is turned on and the previously-on switch matrix is turned off. By circulating the above steps, the whole charging process can be finished.

In one embodiment, preferably, a switch 70 is connected between the battery pack 50 and the first-stage DC/DC converter 211. Through the switch 70, the battery pack 50 can be prevented from being over-discharged via the first-stage DC/DC converter 211 when output of the battery pack 50 is stopped by the controller. Thus, service life of the battery pack 50 is increased.

Referring to FIG. 2, in this embodiment, the DC/DC converter module has at least two operation modes. In a first operation mode, the DC/DC converter module receives the total voltage of all the battery units 52 of the corresponding battery modules 51, and converts the total voltage to a reduced voltage. The reduced voltage is then transmitted to the given battery unit 52 for charging. In a second operation mode, the DC/DC converter module receives a cumulated voltage of part of the battery units 52 of the corresponding battery modules 51, and converts the cumulated voltage. The converted voltage is then transmitted to the given battery unit 52 for charging. It should be noted that said cumulated voltage of the battery units 52 is cumulated by the voltage of all the battery units 52 of one or more of the battery modules 51.

As described above, when the first output voltage of the first-stage DC/DC converter 211 is lower than the second output voltage of the output DC/DC converters, the controller controls the DC/DC converter module to operate under the second operation mode, and one or more second-stage DC/DC converters is selected to obtain power of the second output voltages of one or more output DC/DC converters. Alternatively, when the controller controls the DC/DC converter module to operate under the first operation mode, one or more second-stage DC/DC converters is selected to obtain power of the first output voltage of the first-stage DC/DC converter 211. By alternatively selecting the first and the second operation modes, the battery management system is capable of charging the given battery unit 52 according to different conditions without always charging all the battery units 52. In sum, the charging process becomes more flexible, thereby reducing the power balancing time and improving system efficiency.

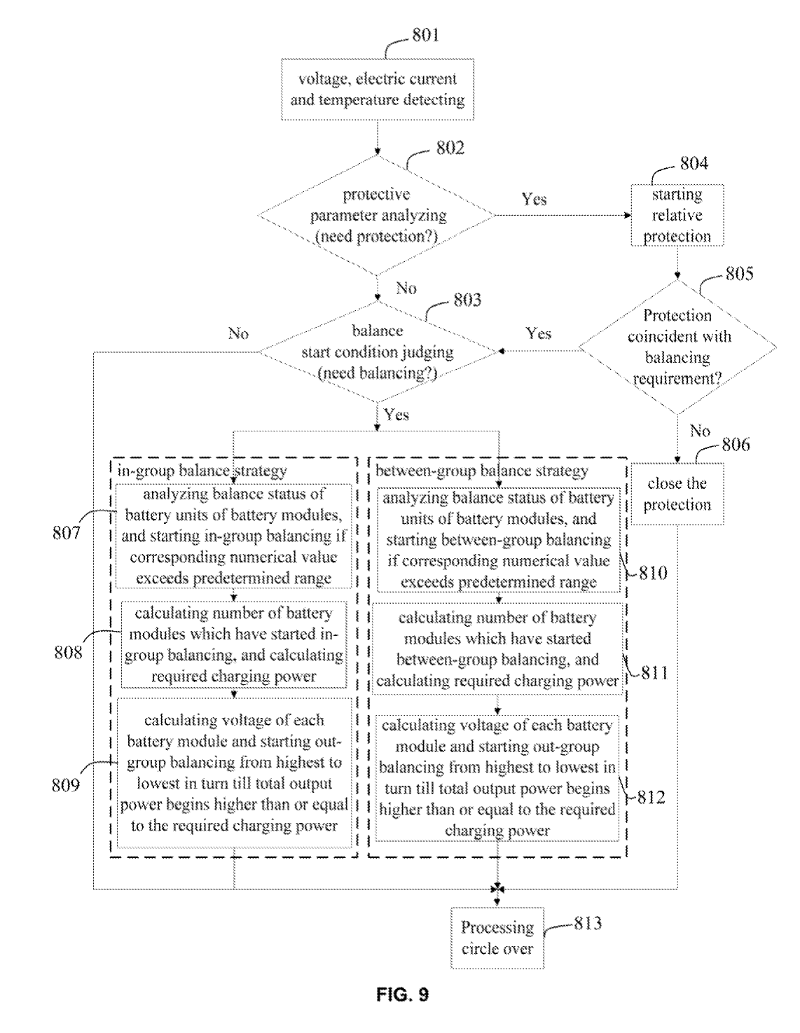

Further referring to FIG. 9, the balancing of the given battery units 52 by the controller is described in detail. Firstly, as shown in step 801, parameters of each battery unit 52 or each battery module 51 of the battery pack 50, including voltage, electric current, temperatures, etc., are detected under the control of the controller. The voltage sensing process includes obtaining voltage of one or more battery units 52 or one or more battery modules 51.

Secondly, as shown in step 802, the parameters obtained in the step 801 are analyzed to determine whether protections, such as overcharging protection, over-discharging protection, short-circuit protection, overheat protection, etc., should be activated. For example, the obtained voltage parameter can be compared with a predetermined voltage threshold. When the obtained voltage exceeds the upper limit of the threshold range, the overcharging protection is activated. When the obtained voltage is lower than the lower limit of the threshold range, the over-discharging protection is activated. In some embodiments, the obtained current parameter can be compared with a predetermined current threshold, and if the obtained current exceeds the threshold, the short-circuit protection is activated. Similarly, the obtained temperature parameter can be compared with a predetermined temperature threshold, and if the obtained temperature exceeds the threshold, the overheat protection is activated.

Further, as shown in step 804, if one or more of the protections should be activated, the overcharging protection, and/or the over-discharging protection, and/or the short-circuit protection, and/or the overheat protection can be activated. Specifically, the overcharging protection requires disconnection of the battery modules 51 from external power sources, and the over-discharging protection requires disconnection of the battery modules 51 from the electric loads.

As shown in step 803, if no protection is needed, the system determines whether the active balancing should be activated. The judging process includes: (I) detecting voltage values of one or more battery units 52 by the controller and then determining whether the maximum voltage value of the detected voltage values is higher than or equal to a first voltage threshold; (II) if so, further determining whether there exists a special voltage value among the detected voltage values or not, the special voltage value is one having a minus numerical value higher than or equal to a second voltage threshold with respect to the maximum voltage value; (III) if so, the controller activates the active balancing process. By the above active balancing process, the given battery units 52 to be charged can be charged in time so as to avoid material degradation. Further, such active balancing process is simple and easy to realize, thereby improving system efficiency as well.

In a detailed embodiment, for example, the first voltage threshold is set as 3.45V and the second voltage threshold is set as 30 mV. In this case, if the maximum voltage value of the battery units 52 of the battery modules 51 is higher than 3.45V, and there exists a battery unit 52 having a minus numerical value higher than or equal to 30 mV with respect to the maximum voltage, the controller activates the active balancing process.

In some embodiments, if active balancing is performed to the battery modules 51 instead of the individual battery units 52, the first voltage threshold is set as 3.45V multiplying the number of the battery units 52 in one battery module 51, and the second voltage threshold is set as 30 mV multiplying the number of the battery units 52 in the one battery module 51. It should be noted that the first voltage threshold and the second voltage threshold can be adjusted according to different design requirements.

As shown in step 805, when a corresponding protection is activated, whether such protection is relative to balancing is determined. In other words, if voltage of each battery unit 52 of the battery modules 51 is too low, e.g. lower than 3.45V, the balancing is closed, as shown in step 806. Thereafter, the current processing circle is over, as shown in step 813. If such protection corresponds to other types of balancing, the step 803 is required.

The obtained voltages of the battery units 52 need further analyzing if actively balancing is needed. If part of the battery units 52 of one or more battery modules 51 need balancing, the controller executes in-group balance strategy, as shown in step 807. As shown in step 808, the controller calculates the required charging power for the given battery units 52 for balancing, and calculates the battery modules 51 with high voltage according to cumulative voltage value as well. Further, the permissible output power of the battery modules 51 is calculated in turn from the highest to the lowest according to the voltage value. When the cumulative permissible output power becomes higher than or equal to the required charging power, the corresponding one or more battery modules 51 for outputting power are determined. As shown in step 809, charging of the given battery unit 52 needed to be balanced begins.

In this embodiment, electric power levels are represented by input/output power of the battery unit 52 in a given time. For example, assuming that the battery pack 50 includes a plurality of battery modules designated as BM1, BM2 . . . BM8, and the maximum voltage value of the battery units 52 of the battery modules BM1, BM2 . . . BM8 is higher than 3.45V, and simultaneously, two battery units 52 of the battery module BM1 and three battery units 52 of the battery module BM4 respectively have voltages no lower than 30 mV comparing with the maximum voltage value. In this case, such two battery units 52 of the battery module BM1 and such three battery units 52 of the battery module BM4 are the so-called given battery units 52 needed to be charged. Thus, the top five highest battery modules 51 according to the cumulative voltage value are shown as BM6, BM7, BM8, BM9, BM10, and the cumulative permissible output power of these five battery modules BM6 to BM10 are calculated in turn till the cumulative permissible output power becomes higher than or equal to the required charging power. Then, the active balancing starts. However, in some embodiments, the electric power levels can be represented by physical characteristic parameters, such as capacitance, voltage, inductance, etc. Further, in the balancing process, the power of the battery module BM6 can be firstly outputted for charging, and if such power is not enough, the power of the battery module BM7 can be then outputted for charging, until the lowest balancing requirement is satisfied.

If voltage of the battery units 52 in the individual battery module 51 is not much different, the controller executes between-group balance strategy to directly charge such battery module 51, as shown in step 810. In this case, the controller calculates the required charging power for the given battery module 52 to get balanced, as shown in step 811, and calculates the battery modules 51 with the high voltage according to the cumulative voltage value. Then, the permissible output power of the above battery modules 51 are calculated in turn from the highest to the lowest according to the voltage value. When the cumulative permissible output power becomes higher than or equal to the required charging power, the corresponding one or more battery modules 51 for outputting power are determined. As shown in step 812, charging of the battery units 52 of the given battery module 51 by the group-outside battery modules 51 begins one by one.

Similarly, in a detailed embodiment, assuming that the battery pack 50 includes a plurality of battery modules designated as BM1, BM2 . . . BM8, and the voltage of each battery module is substantial the same. In this case, if the maximum voltage value of the battery modules BM1, BM2 . . . BM8 is higher than 3.45V multiplying the number of corresponding battery units 52 in one battery module, and there exists at least one battery module BM1, BM2 . . . BM8 having the voltage value no lower than 30 mV multiplying the number of the battery units 52 in the one battery module comparing with the maximum voltage value, similar to the in-group balance strategy, the battery modules with higher voltage are adapted for charging the battery units 52 of the given battery module one by one until the end of the balancing. Detailed description of the active balancing process is omitted herein.

In some embodiments, if the output power of the battery units 52 of the battery modules 51 is lower than the required charging power, the first-stage DC/DC converter 211 is selected to output power for charging the given battery unit or the given battery module. In other words, all the battery modules are adapted for charging the given battery unit or the given battery module.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A battery management system, comprising:
a plurality of battery units connected in series, the battery units comprising a given battery unit needed to be charged;
a DC/DC converter module; and
a controller controlling the DC/DC converter module to operate under one of at least two operation modes, wherein
(i) in a first operation mode, the DC/DC converter module converts a total voltage of all the battery units to a reduced voltage for charging the given battery unit;
(ii) in a second operation mode, the DC/DC converter module converts a cumulated voltage of part of the battery units to a converted voltage for charging the given battery unit.

2. The battery management system as claimed in claim 1, wherein the DC/DC converter module comprises a first-stage DC/DC converter for obtaining the total voltage of all the battery units, the first-stage DC/DC converter outputting a first output voltage lower than the total voltage.

3. The battery management system as claimed in claim 2, wherein the battery units are grouped to form a plurality of battery modules.

4. The battery management system as claimed in claim 3, wherein the cumulated voltage is cumulated by the voltage of all the battery units of one or more of the battery modules.

5. The battery management system as claimed in claim 3, wherein the DC/DC converter module comprises a plurality of output DC/DC converters connected with the plurality of battery modules respectively, each output DC/DC converter being adapted for obtaining the total voltage of all the battery units of a corresponding battery module and selectively outputting a second output voltage after converting the total voltage.

6. The battery management system as claimed in claim 5, wherein the controller controls the DC/DC converter module to work in the second operation mode when the second output voltage is higher than the first output voltage.

7. The battery management system as claimed in claim 5, wherein the DC/DC converter module comprises a plurality of second-stage DC/DC converters respectively connected with the corresponding battery modules, the second-stage DC/DC converters outputting current so as to charge the given battery unit.

8. The battery management system as claimed in claim 7, wherein in the first operation mode, one or more of the second-stage DC/DC converters is selected to obtain the first output voltage of the first-stage DC/DC converter, and in the second operation mode, one or more of the second-stage DC/DC converters is selected to obtain the second output voltages of the output DC/DC converters.

9. The battery management system as claimed in claim 8, further comprising a plurality of switch circuits connected between each second-stage DC/DC converter and the corresponding battery module, each switch circuit being controlled by the controller so as to establish electrical connection of the given battery unit and the corresponding second-stage DC/DC converter.

10. The battery management system as claimed in claim 3, wherein when each of the battery units in the corresponding battery module is the given battery unit, the given battery units get charged one by one under the control of the controller.

11. A method for actively balancing a plurality of battery units connected to each other in series, the method comprising the steps of:
(a) obtaining a voltage value of each individual battery unit or of each group of battery units among all the battery units;
(b) determining whether a maximum voltage value of the voltage values of the battery units is higher than or equal to a first voltage threshold;
(c) if the maximum voltage value is higher than or equal to the first voltage threshold, further determining whether there exists a special voltage value among the voltage values, the special voltage value having a minus numerical value higher than or equal to a second voltage threshold with respect to the maximum voltage value; and
(d) if the special voltage value exists, activating an active balancing to charge a given battery unit having the special voltage value.

12. The method as claimed in claim 11, wherein the battery units are grouped into a plurality of battery modules, and wherein the step (d) further comprises the steps of:
determining one or more battery modules permissible to output power; and
distributing power from the one or more battery modules to charge the given battery unit.

13. The method as claimed in claim 12, wherein the step (d) further comprises the steps of:
calculating a required charging power value for the given battery unit to get balanced; and
identifying one or more battery modules permissible to output power for balancing the given battery unit, wherein said identifying step includes cumulating permissible output power of the battery modules each having the group voltage value within a predetermined voltage range in turn from the highest to the lowest, and determining the one or more battery modules once the cumulative permissible output power begins higher than or equal to the required charging power value.

14. The method as claimed in claim 13, wherein the step of identifying the one or more battery modules permissible to output power further comprises the step of identifying all the battery modules to provide output power for charging when the cumulative permissible output power of all the battery modules is lower than the required charging power value.

15. The method as claimed in claim 13, wherein the permissible output power is represented by an input/output power of the battery unit in a given time.

16. The method as claimed in claim 11, wherein if the voltage value represents cumulative voltage values of a group of battery units, each of the group of battery units is the given battery unit.

17. The method as claimed in claim 16, wherein the step for the active balancing comprises charging each of the group of battery units one by one.

18. A method for actively balancing a plurality of battery modules, each battery module comprising a plurality of battery units connected to each other in series, the method comprising the steps of:
(a) determining a given battery unit which is needed to be charged;
(b) determining one or more battery modules permissible to output power; and
(c) distributing power from the one or more battery modules to charge the given battery unit.

19. The method as claimed in claim 18, wherein the step (a) comprises calculating required charging power value for the given battery unit to get balanced, and wherein the step (b) comprises cumulating permissible output power of the battery modules each having the group voltage value within a predetermined voltage range in turn from the highest to the lowest, and determining the one or more battery modules once the cumulative permissible output power begins higher than or equal to the required charging power value.

20. The method as claimed in claim 18, wherein when each of the battery units in corresponding battery module is the given battery unit, the given battery units in the step (c) get charged one by one.

21. A battery management system, comprising:
a plurality of battery modules, each comprising a plurality of battery units connected to each other in series, the battery units comprising a given battery unit needed to be charged;
a first-stage DC/DC converter for obtaining a total voltage of the battery modules and outputting a first output voltage lower than the total voltage;
at least one output DC/DC converter for obtaining output from at least one of the battery units and outputting a second output voltage;
a plurality of second-stage DC/DC converters electrically connected with the plurality of battery modules respectively, one of the plurality of second-stage DC/DC converters corresponding to the battery module including the given battery unit being adapted for obtaining the first output voltage of the first-stage DC/DC converter or for obtaining the second output voltage of the at least one output DC/DC converter, and outputting current to charge the given battery unit; and
a controller adapted for determining the given battery unit and for determining whether the at least one output DC/DC converter is selected to output current to the second-stage DC/DC converter.

22. The battery management system as claimed in claim 11, wherein the second output voltage is higher than the first output voltage.

23. The battery management system as claimed in claim 11, wherein the at least one output DC/DC converter is adapted for obtaining output from all the battery units of the corresponding battery modules.

24. The battery management system as claimed in claim 11, further comprising a plurality of switch circuits connected between each second-stage DC/DC converter and the corresponding battery module, each switch circuit being controlled by the controller so as to establish electrical connection of the given battery unit and the corresponding second-stage DC/DC converter.

25. The battery management system as claimed in claim 14, wherein each switch circuit comprises a plurality of switch matrixes corresponding to the battery units of the battery modules, the controller controlling on/off status of the corresponding switch matrix to establish the electrical connection of the given battery unit and the corresponding second-stage DC/DC converter.

26. The battery management system as claimed in claim 15, wherein when all of the battery units in a battery module are determined as given battery units, the controller is further adapted for turning on the switch matrixes sequentially, and only one of the switch matrixes is turned on at one time.

27. The battery management system as claimed in claim 11, wherein the controller is adapted for obtaining voltage signals of the battery units so as to determine the given battery unit according to the voltage signals and to determine whether to enable the at least one output DC/DC converter to output power.

28. The battery management system as claimed in claim 11, wherein the first-stage DC/DC converter and the at least one output DC/DC converter are in parallel.

29. The battery management system as claimed in claim 11, further comprising a power storage apparatus combined with the first-stage DC/DC converter, the power storage apparatus being adapted for storage power outputted by the first-stage DC/DC converter for providing power for the second-stage DC/DC converters.

30. The battery management system as claimed in claim 11, further comprising a switch connected between the battery modules and the first-stage DC/DC converter.
